(19) United States
(12) Patent Application Publication
(10) Pub. No.: US 2026/0180038 A1
(43) Pub. Date: Jun. 25, 2026

(54) ELECTROCHEMICAL APPARATUS AND ELECTRONIC DEVICE

(71) Applicant: Ningde Amperex Technology Limited, Ningde (CN)

(72) Inventor: Minjing CHEN, Ningde (CN)

(73) Assignee: Ningde Amperex Technology Limited, Ningde (CN)

(21) Appl. No.: 19/430,551

(22) Filed: Dec. 23, 2025

(30) Foreign Application Priority Data
Dec. 24, 2024 (CN) 202411907519.8

(51) Int. Cl. H01M 10/42; H01M 4/02; H01M 4/62; H01M 10/0569; H01M 50/443; H01M 50/446; H01M 50/489

(52) U.S. Cl. CPC H01M 10/4235; H01M 4/625; H01M 10/0569; H01M 50/443; H01M 50/446; H01M 50/489; H01M 2004/021; H01M 2004/028; H01M 2300/0037

(57) ABSTRACT

An electrochemical apparatus includes a separator, a positive electrode plate, and an electrolyte solution, where the separator includes a porous layer, and an average pore diameter of the porous layer is 0.5 μm to 18 μm; the electrolyte solution includes propyl propionate, and based on a mass of the electrolyte solution, a mass content of propyl propionate is 25% to 55%; and the positive electrode plate includes a positive active material layer, the positive active material layer includes a conductive agent, the conductive agent includes at least one of conductive carbon black or Ketjen black, and a specific surface area of the conductive agent is 600 m²/g to 1100 m²/g.

### CROSS-REFERENCE TO RELATED APPLICATION

This application claims priority to the Chinese Patent Application Serial No. 202411907519.8, filed on Dec. 24, 2024, the disclosure of which is hereby incorporated by reference in its entirety.

### TECHNICAL FIELD

This application relates to the field of electrochemical energy storage, and in particular, to an electrochemical apparatus and an electronic device.

### BACKGROUND

With the diversified application scenarios of electrochemical apparatus such as lithium-ion batteries, lithium-ion batteries, which are widely used in portable electronic devices, drones, electric cleaning tools, electric vehicles, automobiles, and household energy storage devices, are continuously pursuing higher operating voltage, higher energy density, and excellent performance under high and low temperatures. With the widespread application of lithium-ion batteries, a significant demand from users currently lies in minimizing charging time. However, shortening the charging time of lithium-ion batteries is prone to having a noticeable adverse impact on cycle performance and safety performance of the batteries.

### SUMMARY

This application provides an electrochemical apparatus and an electronic device. The electrochemical apparatus of this application exhibits excellent fast-charging performance. Moreover, the electrochemical apparatus of this application exhibits low gas production during overcharging, thus also demonstrating good cycle performance and safety performance.

In a first aspect, this application provides an electrochemical apparatus. The electrochemical apparatus includes a separator, a positive electrode plate, and an electrolyte solution, where the separator includes a porous layer, and an average pore diameter of the porous layer is 0.5 μm to 18 μm; and the electrolyte solution includes propyl propionate, and based on a mass of the electrolyte solution, a mass content of propyl propionate is 25% to 55%; and

Based on the electrochemical apparatus of this application, the average pore diameter of the porous layer of the separator is 0.5 μm to 18 μm, which provides excellent ion transport performance and can shorten the fast-charging time of the electrochemical apparatus. In addition, due to the porous structure, a conventional porous layer has certain structural instability and poor mechanical strength caused by a chemical microstructure. In the electrochemical apparatus of this application, the electrolyte solution includes propyl propionate, and the mass content of propyl propionate is in a range of 25% to 55%, which can enhance the structural stability and mechanical strength of the porous layer. As a result, when the electrochemical apparatus is overcharged under high temperature conditions, the gas production of the electrochemical apparatus can be reduced, so that the electrochemical apparatus has better cycle performance and safety performance.

In one possible embodiment, the average pore diameter of the porous layer is 0.5 μm to 10 μm.

In the above technical solution, the average pore diameter of the porous layer being 0.5 μm to 10 μm is conducive to further improving the fast-charging performance of the electrochemical apparatus and reducing the gas production of the electrochemical apparatus.

In one possible embodiment, the average pore diameter of the porous layer is 5 μm to 10 μm.

In the above technical solution, the average pore diameter of the porous layer being 5 μm to 10 μm is conducive to further improving the fast-charging performance of the electrochemical apparatus and reducing the gas production of the electrochemical apparatus.

In one possible embodiment, based on the mass of the electrolyte solution, the mass content of propyl propionate is 30.5% to 45%.

In the above technical solution, the fast-charging performance of the electrochemical apparatus can be further improved, and the gas production can also be further reduced.

In one possible embodiment, based on the mass of the electrolyte solution, the mass content of propyl propionate is 30.5% to 38.5%.

In the above technical solution, the fast-charging performance of the electrochemical apparatus can be further improved, and gas production can be further reduced.

In one possible embodiment, the electrochemical apparatus satisfies at least one of the following conditions (1) to (4): (1) a thickness of the porous layer is 0.5 μm to 5 μm; (2) the porous layer includes 45 to 95 pores; (3) the porous layer includes inorganic particles, and a polymer of vinylidene fluoride and hexafluoropropylene; or (4) the porous layer includes inorganic particles, and a length-to-diameter ratio of the inorganic particles is 1:5 to 1:1.

In one possible embodiment, the positive electrode plate is provided with bumps, and a height H₁ of the bumps satisfies: 20 μm≤H₁≤70 μm.

In the above technical solution, the bumps on the positive electrode plate can suppress the volume expansion of the electrochemical apparatus during high-temperature storage. Moreover, due to the presence of the bumps, a gap capable of accommodating the electrolyte solution exists between the separator and the positive electrode plate, allowing the separator to be fully infiltrated by the electrolyte solution. This ensures that the electrochemical apparatus maintains a good capacity retention rate even after fast charging.

In one possible embodiment, the positive electrode plate includes a positive active material layer, the positive active material layer includes a conductive agent, the conductive agent includes at least one of conductive carbon black or Ketjen black, and a specific surface area of the conductive agent is 600 m²/g to 1100 m²/g.

In the above technical solution, the conductive carbon black and Ketjen black with specific surface areas can improve the capacity retention rate of the electrochemical apparatus after fast charging and suppress the volume expansion of the electrochemical apparatus during high-temperature storage.

In one possible embodiment, a coating area density of the positive electrode plate is 220 mg/1540.25 mm² to 320 mg/1540.25 mm².

In the above technical solution, the capacity retention rate of the electrochemical apparatus after fast charging can be further improved, and the volume expansion at high temperatures can be better suppressed.

In one possible embodiment, the positive electrode plate includes a binder, the binder includes a first substance, a functional group of the first substance includes a trihydroxy benzene ring, and based on X-ray diffraction characterization, the first substance has n peaks in a diffraction angle range of 50° to 70°, satisfying: 1≤n≤4.

In the above technical solution, the first substance in the binder can improve the capacity retention rate of the electrochemical apparatus after fast charging, capture gas molecules generated by side reactions in the electrolyte solution and an electrode plate interface, and suppress volume expansion of the electrochemical apparatus at high temperatures.

In one possible embodiment, the positive active material layer includes aluminum, a mass content of aluminum is T ppm based on a mass of the positive active material layer, and a thickness of the positive electrode plate is C μm, satisfying: 41.6≤T/C≤77.8.

In the above technical solution, the safety performance of the electrochemical apparatus after overcharging can be further improved, and the capacity retention rate at low temperatures is also relatively high.

In one possible embodiment, 5000≤T≤6400.

In the above technical solution, the safety performance of the electrochemical apparatus after overcharging and the capacity retention rate at low temperatures can be further improved.

In one possible embodiment, the electrolyte solution includes lithium difluorophosphate and diethyl carbonate, and based on the total mass of the electrolyte solution, a mass content of lithium difluorophosphate is X %, and a mass content of diethyl carbonate is Y %, satisfying: 11.1≤Y/X≤500.

In the above solution, the safety performance of the electrochemical apparatus after overcharging can be further improved, and the capacity retention rate at low temperatures is also relatively high.

In one possible embodiment, 20≤Y/X≤360.

In the above technical solution, the safety performance of the electrochemical apparatus after overcharging and the capacity retention rate at low temperatures can be further improved.

In one possible embodiment, the electrolyte solution includes lithium bis(fluorosulfonyl)imide, and based on the total mass of the electrolyte solution, a mass content of lithium bis(fluorosulfonyl)imide is Z %, satisfying: 0.4≤Z≤1.8.

In the above solution, the safety performance of the electrochemical apparatus after overcharging can be further improved, and the capacity retention rate at low temperatures is also relatively high.

In a second aspect, this application provides an electronic device. The electronic device includes the aforementioned electrochemical apparatus. Therefore, the electronic device of this application exhibits excellent use performance.

This application has the beneficial effects:
this application provides the electrochemical apparatus and the electronic device, and the electrochemical apparatus includes the separator, the positive electrode plate, and the electrolyte solution, where the average pore diameter of the porous layer of the separator is 0.5 μm to 18 μm; and the electrolyte solution includes propyl propionate, and based on the mass of the electrolyte solution, the mass content of propyl propionate is 25% to 55%. Through the synergistic effect of the separator and the electrolyte solution, the electrochemical apparatus of this application not only exhibits excellent fast-charging performance, but also has low gas production, so that the electrochemical apparatus has good cycle performance and safety performance.

### DETAILED DESCRIPTION

Embodiments of this application may be described in detail below. No embodiment of this application is to be construed as a limitation on this application.

As used in this application, the terms ‘comprise’, ‘include’, and ‘contain’ are employed in their open, non-limiting sense.

In addition, quantities, ratios, and other values are sometimes presented herein in a range format. It should be understood that such range formats are used for convenience and brevity and should be interpreted flexibly, encompassing not only the numerical values explicitly specified as range limits but also all individual numerical values or sub-ranges covered within the range, as if each numerical value and sub-range were explicitly specified.

In specific implementations and claims, a list of items recited by using the terms such as “one or more of”, “one or more thereof”, “at least one type of” or other similar terms may mean any combination of the recited items. For example, if items A and B are listed, the phrase “at least one of A or B” means only A; only B; or A and B. In another example, if items A, B and C are listed, the phrase “at least one of A, B or C” means A only; or B only; C only; A and B (excluding C); A and C (excluding B); B and C (excluding A); or all of A, B and C. Item A may contain a single component or a plurality of components. Item B may contain a single component or a plurality of components. Item C may contain a single component or a plurality of components.

The electrochemical apparatus and the electronic device of this application will be specifically described below.

In a first aspect, this application provides an electrochemical apparatus. The electrochemical apparatus includes a separator, an electrode plate, and an electrolyte solution. In the electrochemical apparatus of this application, a porous layer in the separator enables the electrochemical apparatus to have good ion transport performance, and propyl propionate in the electrolyte solution can improve the structural stability and mechanical strength of the separator. Therefore, the electrochemical apparatus of this application exhibits excellent ion transport performance, has low gas production during overcharging under high-temperature conditions, and also demonstrates good cycle performance and safety performance.

The structure of the electrochemical apparatus of this application is specifically as follows:

### Separator

The separator of this application includes a porous layer, and an average pore diameter of the porous layer is 0.5 μm to 18 μm, which enables the electrochemical apparatus to achieve good ion transport performance. Thus, the fast-charging time of the electrochemical apparatus is shortened, and the fast-charging performance of the electrochemical apparatus is improved. An average pore diameter that is too small hinders ion transport, while one that is too large provides negligible improvement in ion transport and instead increases the risk of short circuit and reduces the safety performance of the electrochemical apparatus. For example, the average pore diameter of the porous layer may be 0.5 μm, 1 μm, 3 μm, 5 μm, 8 μm, 10 μm, 14 μm, 16 μm, 18 μm, or within any range formed by two of these values. Preferably, the average pore diameter of the porous layer may be 0.5 μm to 10 μm. More preferably, the average pore diameter of the porous layer may be 0.5 μm to 5 μm.

In some embodiments of this application, a thickness of the porous layer is generally 0.5 μm to 5 μm, and the porous layer may include 45 to 90 pores, which enables the separator to achieve both good mechanical strength and excellent ion transport performance.

Additionally, in some embodiments of this application, the porous layer includes inorganic particles, and a polymer of vinylidene fluoride and hexafluoropropylene. A length-to-diameter ratio of the inorganic particles generally ranges from 1:5 to 1:1. Thus, the fast-charging performance of the electrochemical apparatus can be further improved, and the gas production of the electrochemical apparatus is reduced, thereby further improving the cycle performance and safety performance of the electrochemical apparatus.

### Electrolyte Solution

In the electrochemical apparatus of this application, the electrolyte solution includes propyl propionate, and based on the total mass of the electrolyte solution, a mass content of propyl propionate is 25% to 55%, which specifically may be 25%, 28%, 30.5%, 35%, 38.5%, 40%, 45%, 55%, or within a range formed by any two of the aforementioned values.

The applicant found that the porous structure of the porous layer tends to cause structural instability of the separator and poor mechanical strength. Moreover, the applicant also found that when the electrolyte solution includes propyl propionate in the above-mentioned content, the structural stability and mechanical strength of the porous layer can be enhanced, so that gas production in the electrochemical apparatus during overcharging under high-temperature conditions is reduced, and better cycle performance and safety performance are achieved. Preferably, based on the total mass of the electrolyte solution, the mass content of propyl propionate is 30.5% to 45%. More preferably, the mass content of propyl propionate is 30.5% to 38.5%.

In some embodiments of this application, the electrolyte solution further includes lithium difluorophosphate and diethyl phosphate, and based on the mass of the electrolyte solution, the mass content of lithium difluorophosphate is X %, and the mass content of diethyl phosphate is Y %, with 11.1≤Y/X≤500, preferably 20≤Y/X≤360. The applicant found that when the electrolyte solution includes lithium difluorophosphate and diethyl phosphate within the above-mentioned ranges, the safety performance of the electrochemical apparatus after overcharging can be further improved, and the capacity retention rate of the electrochemical apparatus at low temperatures can also be significantly enhanced. Specifically, in some embodiments of this application, X may be 0.05, 0.1, 0.15, 0.2, 0.3, 0.5, 0.6, 0.9, or within a range formed by any two of the aforementioned values; and Y may be 10, 13, 18, 20, 23, 25, or within a range formed by any two of the aforementioned values. Preferably, X is 0.05 to 0.5, and Y is 10 to 18.

Additionally, to improve the safety performance of the electrochemical apparatus after overcharging and the electrical performance at low temperatures, in some embodiments of this application, the electrolyte solution further includes lithium bis(fluorosulfonyl)imide, and based on the total mass of the electrolyte solution, a mass content of lithium bis(fluorosulfonyl)imide is Z %, satisfying: 0.4≤Z≤1.8.

### Positive Electrode Plate

In this application, the structure of the positive electrode plate includes a positive current collector and a positive active material layer disposed on at least one surface of the positive current collector. The positive active material layer includes components such as positive active material, a conductive agent, and a binder. The phrase “positive active material layer disposed on at least one surface of the positive current collector” means that the positive active material layer may be disposed on one surface of the positive current collector in a thickness direction, or on both surfaces of the positive current collector in the thickness direction. Moreover, in this application, the “surface of the positive current collector” may refer to the entire area of the positive current collector, or a partial area thereof, without particular limitation in this application, as long as the purpose of this application can be achieved.

In some embodiments of this application, a surface of the positive electrode plate is provided with bumps, that is, a surface of the positive active material layer is provided with bumps, and a height H₁ of the bumps relative to the surface of the positive electrode plate satisfies: 20 μm≤H₁≤70 μm. The bumps on the positive electrode plate can suppress the volume expansion of the electrochemical apparatus under high temperatures. Moreover, due to the presence of the bumps, a gap capable of accommodating the electrolyte solution exists between the separator and the positive electrode plate, allowing the separator to be fully infiltrated by the electrolyte solution. In this way, the electrochemical apparatus maintains a good capacity retention rate even after fast charging.

In some embodiments of this application, in the positive active material layer, the conductive agent includes at least one of conductive carbon black or Ketjen black, and a specific surface area (BET) of the conductive agent is generally 600 m²/g to 1100 m²/g. In this way, the capacity retention rate of the electrochemical apparatus after fast charging can be improved, and the volume expansion of the electrochemical apparatus under high temperatures can be suppressed.

Certainly, in some other embodiments of this application, the conductive agent may also be a carbon nanotube or graphene.

In some embodiments of this application, in the positive active material layer of the positive electrode plate, the binder includes a first substance which includes a functional group with a trihydroxy benzene ring. Based on X-ray diffraction (XRD) characterization, the first substance has n peaks in a diffraction angle range of 50° to 70°, satisfying: 1≤n≤4. In this way, the capacity retention rate of the electrochemical apparatus after fast charging can also be improved, and the volume expansion of the electrochemical apparatus under high temperatures can be suppressed. For example, the first substance may be a polymer, the structural units of which include but are not limited to

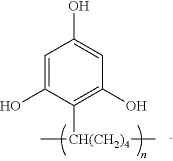

The specific structure and type of the first substance are not particularly limited in this application, as long as the first substance includes the trihydroxy benzene ring and can achieve the objectives of this application. Certainly, in some other embodiments of this application, the binder in the positive electrode plate may further include, but is not limited to, any one or at least two of the following: resin-based polymers such as polyethylene, polypropylene, polyethylene terephthalate, polymethyl methacrylate, polyimide, aromatic polyamide, cellulose, or nitrocellulose; rubber-like polymers such as styrene-butadiene rubber (SBR), acrylonitrile-butadiene rubber (NBR), fluororubber, isoprene rubber, butadiene rubber, or ethylene-propylene rubber; thermoplastic elastomer-like polymers such as a styrene-butadiene-styrene block copolymer or its hydride, an ethylene-propylene-diene terpolymer (EPDM), a styrene-ethylene-butadiene-ethylene copolymer, and a styrene-isoprene-styrene block copolymer or its hydride; soft resin-like polymers such as syndiotactic 1,2-polybutadiene, polyvinyl acetate, an ethylene-vinyl acetate copolymer, or a propylene-α-olefin copolymer; fluorine-based polymers such as polyvinylidene difluoride (PVDF), polytetrafluoroethylene, fluorinated polyvinylidene difluoride, or a polytetrafluoroethylene-ethylene copolymer; and polymer compositions with ionic conductivity of alkali metal ions (particularly lithium-ion).

Furthermore, in some embodiments of this application, the positive active material layer includes aluminum, and based on a mass content of the positive active material layer, a mass content of aluminum is T ppm. The relationship between a value of T and a thickness C μm of the positive electrode plate may satisfy: 41.6≤T/C≤77.8. As an example, the values of C and T may be: C∈[90, 120] μm, T∈[5000, 7000] ppm, preferably T∈[5000, 6400] ppm. In this way, the safety performance of the electrochemical apparatus after overcharging and the capacity retention rate at low temperatures can be improved.

The aluminum may originate from either the positive active material or the inorganic particles in the separator. The positive active material is not particularly limited in this application, as long as the objectives of this application can be achieved. For example, the positive active material includes, but is not limited to, at least one of lithium iron phosphate (LiFePO₄), lithium cobalt oxide (LiCoO₂), lithium manganese oxide, lithium nickel oxide, or a ternary material. The ternary material includes, but is not limited to, at least one of LiNiₓCo_{y}Mn_{z}O₂, LiNiₓCo_{y}Al_{z}O₂, etc., and the content of Ni, Co, Mn, Al, etc. may be adjusted to ensure that x+y+z=1. For example, the ternary material may be LiNi_{0.6}Co_{0.2}Mn_{0.2}O₂, LiNi_{0.88}Co_{0.08}Mn_{0.04}O₂, LiNi_{0.8}Co_{0.15}Mn_{0.05}O₂, LiNi_{0.8}Co_{0.1}Mn_{0.1}O₂, LiNi_{0.88}Co_{0.1}Mn_{0.02}O₂, LiNi_{0.8}Co_{0.15}Al_{0.05}O₂, LiNi_{0.88}Co_{0.1}Al_{0.02}O₂, etc.

In some embodiments of this application, the coating area density of the positive electrode plate is generally within the range of 220 mg/1540.25 mm² to 320 mg/1540.25 mm², which is also conducive to improving the safety performance of the electrochemical apparatus after overcharging and the capacity retention rate at low temperatures.

In the positive electrode plate, the type of the positive current collector is not particularly limited, and the positive current collector may be any material known to be suitable for use as a positive current collector. The material of the positive current collector includes, but is not limited to, metal materials such as aluminum, stainless steel, nickel plating, titanium, or tantalum. In addition, to reduce the electronic contact resistance between the positive current collector and the positive active material layer, the surface of the positive current collector may be provided with a conductive auxiliary or a conductive coating. The conductive auxiliary includes, but is not limited to, carbon or noble metals such as gold, platinum, or silver. The conductive coating may be a mixture layer of an inorganic oxide, a conductive agent, and a positive electrode binder.

When preparing the positive electrode plate, a method can be dissolving or dispersing the components in the positive active material layer in a liquid solvent to form a positive electrode slurry, and then coating the positive electrode slurry onto the positive current collector and performing drying to form the positive active material layer on the positive current collector, then obtaining the positive electrode plate. When the positive electrode plate is prepared using this method, the solvent in the positive electrode slurry is not particularly limited as long as the solvent can dissolve or disperse the aforementioned components. Specifically, the solvent in the positive electrode slurry includes, but is not limited to, N-methyl-pyrrolidone (NMP) and ethylene carbonate (EC). Additionally, when preparing the positive electrode plate, the method can also be: dry mixing the components of the positive active material layer to form a sheet, and pressing the sheet onto the positive current collector.

### Negative Electrode Plate

The negative electrode plate includes a negative current collector and a negative active material layer disposed on at least one surface of the negative current collector. Components of the negative active material layer include negative active material. That is, in this application, the negative active material layer may be disposed on one surface of the negative current collector in a thickness direction, or on both surfaces of the negative current collector in the thickness direction. Moreover, in this application, the “surface of the negative current collector” may refer to the entire area of the negative current collector or a partial area thereof, without particular limitation in this application, as long as the objectives of this application can be achieved.

The negative active material layer generally includes negative active material, which is not particularly limited in this application. Specifically, the negative active material may include at least one of carbon material or silicon-based material. More specifically, the carbon material includes, but is not limited to, at least one of natural graphite, artificial graphite, mesocarbon microbeads, hard carbon, or soft carbon. The silicon-based material includes, but is not limited to, at least one of silicon, silicon-oxygen composite material, or silicon-carbon composite material.

In some embodiments, the negative active material layer usually also includes a negative electrode conductive agent. The negative electrode conductive agent is not particularly limited in this application, as long as the objectives of this application can be achieved. For example, the negative electrode conductive agent includes, but is not limited to, at least one of acetylene black, Ketjen black, a carbon nanotube, carbon fibers, carbon dots, or graphene.

In some embodiments, the negative active material layer may also include a negative electrode binder and a thickener. The types of the negative electrode binder and the thickener are not particularly limited in this application, as long as the objectives of this application can be achieved. For example, the negative electrode binder may include, but is not limited to, at least one of polyvinyl alcohol, polyvinyl chloride, carboxylated polyvinyl chloride, polyvinyl fluoride, polyvinyl pyrrolidone, polyurethane, polytetrafluoroethylene, polyvinylidene difluoride, styrene-butadiene rubber, or acrylic acid-modified styrene-butadiene rubber. The thickener in the negative electrode slurry may include, but is not limited to, at least one of sodium carboxymethyl cellulose or lithium carboxymethyl cellulose.

In the negative electrode plate, the material of the negative current collector includes, but is not limited to, copper foil, nickel foil, stainless steel foil, titanium foil, foamed nickel, foamed copper, or a polymer substrate coated with a conductive metal, which is not particularly limited in this application. The conductive metal includes, but is not limited to, copper, nickel, or titanium. The material of the polymer substrate includes, but is not limited to, at least one of polyethylene, polypropylene, poly(ethylene-co-propylene), polyethylene terephthalate, polyethylene naphthalate, or poly(p-phenylene terephthalamide).

Additionally, in this application, the thicknesses of the negative current collector and the negative active material layer are not particularly limited, as long as the objectives of this application can be achieved. For example, the thickness of the negative current collector is 4 μm to 12 μm, and the thickness of the single-sided negative active material layer is 30 μm to 160 μm.

In addition, similar to preparing the positive electrode plate, when preparing the negative electrode plate, a method can be preparing the negative electrode slurry, and coating the negative electrode slurry onto the negative current collector and performing drying to form the negative active material layer on the negative current collector, then obtaining the negative electrode plate. Alternatively, the method can also be: dry mixing the components of the negative active material layer to form a sheet, and pressing the obtained sheet onto the negative current collector to form the negative active material layer, then obtaining the negative electrode plate. The solvent in the negative electrode slurry includes any one of an aqueous solvent or organic solvents. The aqueous solvent includes, but is not limited to, a mixed solvent of alcohol and water or water. The organic solvents include, but are not limited to, aliphatic hydrocarbons such as hexane. aromatic hydrocarbons such as benzene, toluene, xylene, and methylnaphthalene; heterocyclic compounds such as quinoline and pyridine; ketones such as acetone, methyl ethyl ketone, and cyclohexanone; esters such as methyl acetate and methyl acrylate; amines such as diethylenetriamine and N,N-dimethylaminopropylamine; ethers such as diethyl ether, propylene oxide, and tetrahydrofuran (THF); amides such as N-methyl-pyrrolidone (NMP), dimethylformamide, and dimethylacetamide; or non-protonic polar solvents such as hexamethylphosphoramide and dimethyl sulfoxide. Additionally, in some other embodiments, when using the aqueous solvent, the components of the negative electrode slurry may also include a thickener and a styrene-butadiene rubber (SBR) emulsion to slurryize the negative electrode slurry, thereby adjusting the viscosity of the negative electrode slurry. The types of the thickener in the positive electrode slurry include, but are not limited to, at least one of carboxymethylcellulose, methylcellulose, hydroxymethyl cellulose, ethyl cellulose, polyvinyl alcohol, oxidized starch, phosphorylated starch, casein, or salts thereof.

The electrochemical apparatus of this application further includes a packaging bag for accommodating the positive electrode plate, the separator, the negative electrode plate, the electrolyte solution, and other components known in the art for the electrochemical apparatus. This application does not limit the aforementioned other components. The packaging bag is not particularly limited in this application, and may be a packaging bag well known in the art, as long as the objectives of this application can be achieved.

In a second aspect, this application further provides an electronic device. The electronic device includes the electrochemical apparatus according to this application.

The use of the electrochemical apparatus of this application is not specifically limited and the electrochemical apparatus may be used in any electronic device known in the prior art. In some embodiments, the electrochemical apparatus of this application may be used in, but is not limited to, a notebook computer, a pen-input computer, a mobile computer, an electronic book player, a portable phone, a portable fax machine, a portable copier, a portable printer, a headphone, a video recorder, a liquid crystal television, a hand-held cleaner, a portable CD machine, a mini disc, a transceiver, an electronic organizer, a calculator, a memory card, a portable audio recorder, a radio, a backup power supply, a motor, an automobile, a motorcycle, a power bicycle, a bicycle, a lighting appliance, a toy, a game machine, a clock, an electric tool, a flash light, a camera, a large household storage battery, a lithium-ion capacitor, etc.

### EMBODIMENTS

The following takes lithium-ion secondary batteries as examples to provide embodiments and comparative embodiments for more specifically illustrating the implementations of the electrochemical apparatus in this application. A person skilled in the art should understand that the preparation method described in this application is merely exemplary, and any other suitable preparation methods fall within the scope of this application.

### Measurement Methods and Devices

### Fast-Charge Capacity Retention Rate Measurement:

At −10° C., performing a constant current charging test on the lithium-ion batteries prepared in the embodiments and comparative embodiments at a rate of 1.5 C to calculate rate charging capacity retention rates thereof, where charging retention rate of a battery at a rate of 1.5 C=capacity discharged after charging at a rate of 1.5 C/capacity discharged after charging at a rate of 0.5 C.

### Intermittent Cycle Test (−10° C.):

Before the test, measuring a thickness Do of a fully charged battery cell. Placing the battery in a (−10±3)° C. environment and standing for 3 hours. When a battery cell body reaches (−10±3° C.), charging the battery to 4.5 V at a constant current of 0.8 C, charging the battery to a cutoff current of 0.05 C at a constant voltage of 4.5 V, then leaving the battery to stand at −10° C. for 6 hours, ensuring that a total time of the constant current charging time, constant voltage charging time, and the standing time equals 24 hours, discharging at 0.5 C, and recording the initial energy E₀. Repeating the foregoing operation for several cycles, when a number of cycles reaches a required number, recording the discharge energy of this time as the battery energy E₁, and calculating the energy retention rate (%), where energy retention rate (%)=E₁/E₀×100%.

### Gas Production Test:

At 25° C., performing cycling the battery at a rate of 1 C for 20 cycles with a test voltage range of 2.0 V to 4.5 V. Detecting the gas production of the battery after cycling by a battery gas production tester.

### Overcharge Test Pass Rate:

Under the condition of (45±5° C.), charging a discharged battery cell to 5.0 V at a constant current of 3.5 C, then charging at a constant voltage, and limiting constant voltage charging time to 6 hours or stopping charging when the surface temperature of the battery stabilizes (a temperature difference within 30 minutes being ≤2° C.). Evaluation criteria: the battery cell does not catch fire, with each embodiment tested using 20 parallel samples as a group.

### Volume Expansion Test for High-Temperature (75° C.) Storage:

At room temperature, charging the battery cell to the charge cut-off voltage at a constant current of 2 C, and then charging to constant voltage until the current drops to 0.1 C, then storing the battery cell in a 75° C. constant-temperature oven for 15 hours. Recording the volume change rate before and after high-temperature storage.

### 5 C Full Charge Time Test:

Taking a finished battery cell, at 25° C., discharging at 0.7 C to a set value, when the positive active material is LCO, the voltage is 3.0 V. Charging the battery cell at 5 C to the cutoff voltage, then charging to 0.05 C at the cutoff voltage, and recording the total charging time.

### High-Temperature Cycle Capacity Retention Rate Test for Lithium-Ion Battery:

At 45° C., charging the lithium-ion battery to 4.5 V at a constant current of 1 C, and then charging at a constant voltage of 4.5 V until the current reaches 0.05 C, followed by discharging to 3.0 V at a constant current of 0.8 C, thereby forming a first cycle. Performing 300 cycles on the lithium-ion battery under the aforementioned conditions. “1 C” refers to a current value required to fully discharge the battery capacity within 1 hour.

The cycle capacity retention rate of the lithium-ion battery is calculated as follows: 300-cycle capacity retention rate=(discharge capacity at the 300th cycle/discharge capacity at the first cycle)×100%.

### Electrolyte Solution Component Analysis Test:

Using GC-MS (gas chromatography-mass spectrometry) and IC (ion chromatography) test methods for analysis, with combination of an external standard method.

### Embodiment 1-1

### <Preparing an Electrolyte Solution>

In an argon gas atmosphere glove box with a water content of less than 10 ppm, mixing ethyl methyl carbonate and ethyl acetate in a mass percentage of 1:1 to prepare a base solvent, and then adding lithium salt lithium hexafluorophosphate (LiPF₆), propyl propionate, lithium difluorophosphate, diethyl carbonate, and lithium bis(fluorosulfonyl)imide to form an electrolyte solution. Based on the total mass of the electrolyte solution, the mass percentage of LiPF₆ is 9%, the mass contents of propyl propionate, lithium difluorophosphate, diethyl carbonate, and lithium bis(fluorosulfonyl)imide are shown in Tables 1 and 3, and the balance is the base solvent.

### <Preparing a Separator>

Selecting a polyethylene (PE) microporous membrane with a thickness of 6 μm as a substrate for a separator; then, dispersing inorganic particles of boehmite with a length-to-diameter ratio of 1:1 and a polyvinylidene fluoride-hexafluoropropylene copolymer (PVDF-HFP) in deionized water at a mass ratio of 85:15 to form a porous layer slurry with a solid content of 48%. Coating the porous layer slurry onto both surfaces of the PE substrate via gravure roll coating and drying to form a porous layer adhered to the surfaces of the PE substrate. The porous layer has a thickness of 2 μm and an average pore diameter of 0.5 μm, and each porous layer has 50 pores. The parameters of the porous layer of the separator are shown in Table 2.

### <Preparing a Positive Electrode Plate>

Mixing the lithium cobalt oxide as the positive active material, the conductive carbon black as the conductive agent, and the first substance as the binder at a mass ratio of 95:2:3, and adding N-methyl-pyrrolidone (NMP). Under the action of a vacuum mixer, uniformly stirring the mixture to obtain a positive electrode slurry with a solid content of 70 wt %. Uniformly coating the positive electrode slurry onto upper surface and lower surface of the aluminum foil as the positive current collector, followed by drying, pressing, and cutting to specified dimensions to obtain the positive electrode plate. Then, calendering the surface of the positive electrode plate to form bumps, and a height H₁ of the bumps is 20 μm.

The conductive carbon black has a BET value of 700 m²/g, and has 4 peaks at a diffraction angle of 50° to 70° through XRD characterization. The coating area density of the prepared positive electrode plate is 220 mg/1540.25 mm², the thickness C is 100 μm, and based on the mass of the positive active material layer, a content of aluminum element is 5000 ppm. The specific parameters of the positive electrode plate are shown in Table 2 and Table 3.

### <Preparing a Negative Electrode Plate>

Mixing artificial graphite, styrene-butadiene rubber (SBR), polyacrylic acid (PAA), a carbon nanotube (CNT), and carboxymethylcellulose (CMC) at a mass ratio of 95.8:2.4:0.5:0.5:0.8, then adding deionized water as the solvent and stirring uniformly to prepare a negative electrode slurry with a solid content of 45 wt %. Uniformly coating the negative electrode slurry on both surfaces of the negative current collector copper foil, followed by drying, pressing, and cutting to specified dimensions to obtain the negative electrode plate.

### <Preparing an Electrochemical Apparatus>

Stacking the prepared positive electrode, separator, negative electrode, and separator in sequence, ensuring that the separator is placed between the positive electrode and the negative electrode to provide isolation, and then winding the components to obtain the electrode assembly. Welding tabs, then placing the electrode assembly into an aluminum laminated film packaging bag and drying in an 85° C. vacuum oven for 12 hours to remove moisture. Injecting the prepared electrolyte solution into the bag, and performing the steps of vacuum sealing, standing, formation, shaping, and capacity testing to obtain the lithium-ion battery.

### Embodiment 1-2 to Embodiment 1-32

Identical to Embodiment 1-1 except that the corresponding parameters are adjusted according to Table 1.

### Comparative Embodiment 1 to Comparative Embodiment 6

Identical to Embodiment 1-1 except that the corresponding parameters are adjusted according to Table 1.

TABLE 1

| | | | | | Length-to- | | Capacity | |
|---|---|---|---|---|---|---|---|---|
| | | | | | diameter | | retention | |
| | Average | | | | ratio of | | rate after | |
| | pore | Mass | | Number | inorganic | | 300 cycles | |
| | diameter of | percentage | Thickness | of pores | particles | Gas | at high | 5 C full |
| | porous | of propyl | of porous | in porous | in porous | production/ | temperature | charge |
| Group | layer/μm | propionate/% | layer/μm | layer/pcs | layer | μL | of 45° C./% | time/min |
| Embodiment 1-1 | 0.5 | 32 | 2 | 50 | 1:1 | 7.6 | 86.6 | 28 |
| Embodiment 1-2 | 2 | 32 | 2 | 56 | 1:1 | 7.4 | 86.9 | 27.5 |
| Embodiment 1-3 | 4 | 32 | 2 | 63 | 1:1 | 7.2 | 87.2 | 27 |
| Embodiment 1-4 | 5 | 32 | 2 | 70 | 1:1 | 6.8 | 88.2 | 23.5 |
| Embodiment 1-5 | 6 | 32 | 2 | 73 | 1:1 | 6.5 | 89.3 | 23 |
| Embodiment 1-6 | 8 | 32 | 2 | 78 | 1:1 | 6.1 | 90.2 | 22.5 |
| Embodiment 1-7 | 10 | 32 | 2 | 82 | 1:1 | 5.5 | 91.5 | 21 |
| Embodiment 1-8 | 12 | 32 | 2 | 86 | 1:1 | 7 | 87.5 | 27.5 |
| Embodiment 1-9 | 14 | 32 | 2 | 90 | 1:1 | 7.2 | 86.4 | 27.5 |
| Embodiment 1-10 | 18 | 32 | 2 | 95 | 1:1 | 7.4 | 85.6 | 28.5 |
| Embodiment 1-11 | 6 | 25 | 2 | 70 | 1:1 | 8.2 | 85.2 | 29 |
| Embodiment 1-12 | 6 | 28 | 2 | 74 | 1:1 | 8 | 87.1 | 28.5 |
| Embodiment 1-13 | 6 | 30.5 | 2 | 73 | 1:1 | 6.7 | 88.2 | 25.5 |
| Embodiment 1-14 | 6 | 35 | 2 | 72 | 1:1 | 5.5 | 89.3 | 24 |
| Embodiment 1-15 | 6 | 38.5 | 2 | 70 | 1:1 | 6.2 | 90.8 | 22.5 |
| Embodiment 1-16 | 6 | 40 | 2 | 72 | 1:1 | 7.2 | 87.4 | 26.5 |
| Embodiment 1-17 | 6 | 42 | 2 | 72 | 1:1 | 7.5 | 86.8 | 27 |
| Embodiment 1-18 | 6 | 45 | 2 | 70 | 1:1 | 7.8 | 86.3 | 27.5 |
| Embodiment 1-19 | 6 | 50 | 2 | 70 | 1:1 | 8 | 85.9 | 28 |
| Embodiment 1-20 | 6 | 55 | 2 | 71 | 1:1 | 8.2 | 85.5 | 28.5 |
| Embodiment 1-21 | 6 | 32 | 0.5 | 47 | 1:1 | 7.1 | 85.8 | 29 |
| Embodiment 1-22 | 6 | 32 | 4 | 63 | 1:1 | 7.8 | 86.9 | 27.5 |
| Embodiment 1-23 | 6 | 32 | 5 | 68 | 1:1 | 8 | 85.3 | 26.5 |
| Embodiment 1-24 | 6 | 32 | 2 | 49 | 1:2 | 7.4 | 86.8 | 26 |
| Embodiment 1-25 | 6 | 32 | 2 | 48 | 1:3 | 7.1 | 87.2 | 25.5 |
| Embodiment 1-26 | 6 | 32 | 2 | 46 | 1:4 | 6.8 | 87.5 | 25 |
| Embodiment 1-27 | 6 | 32 | 2 | 45 | 1:5 | 6.5 | 88.2 | 24 |
| Embodiment 1-28 | 6 | 27 | 2 | 72 | 1:1 | 9.5 | 79.8 | 31.5 |
| Embodiment 1-29 | 6 | 32 | 0.3 | 44 | 1:1 | 8.4 | 82.5 | 30 |
| Embodiment 1-30 | 6 | 32 | 5.2 | 70 | 1:1 | 8.7 | 82.1 | 30.5 |
| Embodiment 1-31 | 6 | 32 | 2 | 43 | 1:6 | 8 | 83.1 | 31 |
| Embodiment 1-32 | 6 | 32 | 2 | 102 | 2:1 | 8.2 | 83.5 | 30.5 |
| Comparative | 19 | 32 | 2 | 97 | 1:1 | 9.8 | 79.5 | 33 |
| Embodiment 1 | | | | | | | | |
| Comparative | 20 | 32 | 2 | 100 | 1:1 | 10.5 | 77.4 | 34 |
| Embodiment 2 | | | | | | | | |
| Comparative | 6 | 58 | 2 | 71 | 1:1 | 11.4 | 78.3 | 32 |
| Embodiment 3 | | | | | | | | |
| Comparative | 19 | 27 | 2 | 98 | 1:1 | 13.5 | 74.5 | 35.5 |
| Embodiment 4 | | | | | | | | |
| Comparative | 0.3 | 32 | 2 | 48 | 1:1 | 14.1 | 73.2 | 37.5 |
| Embodiment 5 | | | | | | | | |
| Comparative | 6 | 23 | 2 | 70 | 1:1 | 11.8 | 73.8 | 33 |
| Embodiment 6 | | | | | | | | |

### Embodiment 2-1 to Embodiment 2-27

Identical to Embodiment 1-1 except that the parameters of the positive electrode plate are adjusted according to Table 2. Additionally, in Embodiment 2-27, the binder in the positive electrode plate is PVDF.

TABLE 2

| | | | | | | | 75° C. |
|---|---|---|---|---|---|---|---|
| | | | | Coating | | | storage |
| | | Type of | BET of | area | Number of | | volume |
| | | conductive | conductive | density/(mg/ | characteristic | Fast charge test | expansion |
| Group | H₁/μm | agent | agent/(m²/g) | 1540.25 mm²) | peaks | retention rate/% | rate/% |
| Embodiment 1-1 | 20 | Conductive | 700 | 220 | 4 | 85.7 | 4.8 |
| | | carbon black | | | | | |
| Embodiment 2-1 | 30 | Conductive | 700 | 220 | 4 | 86 | 4.6 |
| | | carbon black | | | | | |
| Embodiment 2-2 | 40 | Conductive | 700 | 220 | 4 | 86.3 | 4.3 |
| | | carbon black | | | | | |
| Embodiment 2-3 | 50 | Conductive | 700 | 220 | 4 | 86.8 | 3.8 |
| | | carbon black | | | | | |
| Embodiment 2-4 | 60 | Conductive | 700 | 220 | 4 | 87.2 | 4.2 |
| | | carbon black | | | | | |
| Embodiment 2-5 | 70 | Conductive | 700 | 220 | 4 | 86.5 | 4.6 |
| | | carbon black | | | | | |
| Embodiment 2-6 | 50 | Ketjen black | 700 | 220 | 4 | 84.9 | 5.1 |
| Embodiment 2-7 | 50 | Conductive | 700 | 220 | 4 | 85.2 | 4.9 |
| | | carbon black | | | | | |
| | | and Ketjen | | | | | |
| | | black | | | | | |
| Embodiment 2-8 | 50 | Conductive | 600 | 220 | 4 | 84.9 | 5.1 |
| | | carbon black | | | | | |
| Embodiment 2-9 | 50 | Conductive | 800 | 220 | 4 | 86.2 | 4.7 |
| | | carbon black | | | | | |
| Embodiment 2-10 | 50 | Conductive | 900 | 220 | 4 | 86.5 | 4.5 |
| | | carbon black | | | | | |
| Embodiment 2-11 | 50 | Conductive | 1000 | 220 | 4 | 87.1 | 4.3 |
| | | carbon black | | | | | |
| Embodiment 2-12 | 50 | Conductive | 1100 | 220 | 4 | 87.5 | 4 |
| | | carbon black | | | | | |
| Embodiment 2-13 | 50 | Conductive | 700 | 250 | 4 | 86.5 | 4.5 |
| | | carbon black | | | | | |
| Embodiment 2-14 | 50 | Conductive | 700 | 270 | 4 | 86.9 | 4.8 |
| | | carbon black | | | | | |
| Embodiment 2-15 | 50 | Conductive | 700 | 300 | 4 | 87.2 | 5.1 |
| | | carbon black | | | | | |
| Embodiment 2-16 | 50 | Conductive | 700 | 320 | 4 | 87.5 | 5.3 |
| | | carbon black | | | | | |
| Embodiment 2-17 | 50 | Conductive | 700 | 220 | 3 | 85.2 | 5.1 |
| | | carbon black | | | | | |
| Embodiment 2-18 | 50 | Conductive | 700 | 220 | 2 | 84.5 | 5.2 |
| | | carbon black | | | | | |
| Embodiment 2-19 | 50 | Conductive | 700 | 220 | 1 | 83.4 | 5.4 |
| | | carbon black | | | | | |
| Embodiment 2-20 | 10 | Conductive | 700 | 220 | 4 | 84.1 | 6.2 |
| | | carbon black | | | | | |
| Embodiment 2-21 | 80 | Conductive | 700 | 220 | 4 | 83.7 | 6.5 |
| | | carbon black | | | | | |
| Embodiment 2-22 | 50 | Carbon | 700 | 220 | 4 | 84.2 | 6.1 |
| | | nanotube | | | | | |
| Embodiment 2-23 | 50 | Conductive | 1150 | 220 | 4 | 83.2 | 6.2 |
| | | carbon black | | | | | |
| Embodiment 2-24 | 50 | Conductive | 550 | 220 | 4 | 83.9 | 5.8 |
| | | carbon black | | | | | |
| Embodiment 2-25 | 50 | Conductive | 700 | 330 | 4 | 84.3 | 5.7 |
| | | carbon black | | | | | |
| Embodiment 2-26 | 50 | Conductive | 700 | 210 | 4 | 84.1 | 5.6 |
| | | carbon black | | | | | |
| Embodiment 2-27 | 50 | Conductive | 700 | 220 | 0 | 83.1 | 5.7 |
| | | carbon black | | | | | |

Note: The “number of characteristic peaks” in Table 2 refers to the number of characteristic peaks of the first substance within the diffraction angle range of 50° to 70° during XRD characterization; and H₁ represents the height of bumps.

### Embodiment 3-1 to Embodiment 3-40

Identical to Embodiment 1-1 except that the parameters of the positive electrode plate and the electrolyte solution are adjusted according to Table 3.

TABLE 3

| | | | | | | | | Intermittent | |
|---|---|---|---|---|---|---|---|---|---|
| | | | | | | | | cycle test | Overcharge |
| | | | | | | | | retention rate | test pass |
| Group | X/% | Y/% | Y/X | Z/% | C/μm | T/ppm | T/C | (−10° C.)/% | rate/% |
| Embodiment 1-1 | 0.05 | 10 | 200.0 | 0.9 | 100 | 5000 | 50.0 | 87.5 | 95 |
| Embodiment 3-1 | 0.1 | 10 | 100.0 | 0.9 | 100 | 5000 | 50.0 | 88.2 | 95 |
| Embodiment 3-2 | 0.2 | 10 | 50.0 | 0.9 | 100 | 5000 | 50.0 | 88.5 | 100 |
| Embodiment 3-3 | 0.3 | 10 | 33.3 | 0.9 | 100 | 5000 | 50.0 | 89.2 | 100 |
| Embodiment 3-4 | 0.4 | 10 | 25.0 | 0.9 | 100 | 5000 | 50.0 | 89.5 | 100 |
| Embodiment 3-5 | 0.5 | 10 | 20.0 | 0.9 | 100 | 5000 | 50.0 | 90.5 | 95 |
| Embodiment 3-6 | 0.6 | 10 | 16.7 | 0.9 | 100 | 5000 | 50.0 | 86.2 | 90 |
| Embodiment 3-7 | 0.8 | 10 | 12.5 | 0.9 | 100 | 5000 | 50.0 | 86 | 90 |
| Embodiment 3-8 | 0.9 | 10 | 11.1 | 0.9 | 100 | 5000 | 50.0 | 85.9 | 90 |
| Embodiment 3-9 | 0.1 | 15 | 150.0 | 0.9 | 100 | 5000 | 50.0 | 88.1 | 100 |
| Embodiment 3-10 | 0.1 | 18 | 180.0 | 0.9 | 100 | 5000 | 50.0 | 89.3 | 100 |
| Embodiment 3-11 | 0.1 | 19 | 190.0 | 0.9 | 100 | 5000 | 50.0 | 86.8 | 85 |
| Embodiment 3-12 | 0.1 | 22 | 220.0 | 0.9 | 100 | 5000 | 50.0 | 86.4 | 85 |
| Embodiment 3-13 | 0.1 | 25 | 250.0 | 0.9 | 100 | 5000 | 50.0 | 86.2 | 85 |
| Embodiment 3-14 | 0.05 | 25 | 500.0 | 0.9 | 100 | 5000 | 50.0 | 85.5 | 80 |
| Embodiment 3-15 | 0.9 | 25 | 27.8 | 0.9 | 100 | 5000 | 50.0 | 88.5 | 90 |
| Embodiment 3-16 | 0.05 | 18 | 360.0 | 0.9 | 100 | 5000 | 50.0 | 87.5 | 95 |
| Embodiment 3-17 | 0.1 | 10 | 100.0 | 0.4 | 100 | 5000 | 50.0 | 86.5 | 90 |
| Embodiment 3-18 | 0.1 | 10 | 100.0 | 0.7 | 100 | 5000 | 50.0 | 86.7 | 90 |
| Embodiment 3-19 | 0.1 | 10 | 100.0 | 1.2 | 100 | 5000 | 50.0 | 87.2 | 95 |
| Embodiment 3-20 | 0.1 | 10 | 100.0 | 1.6 | 100 | 5000 | 50.0 | 87.6 | 95 |
| Embodiment 3-21 | 0.1 | 10 | 100.0 | 1.8 | 100 | 5000 | 50.0 | 88.2 | 100 |
| Embodiment 3-22 | 0.1 | 10 | 100.0 | 0.9 | 90 | 5000 | 55.6 | 86.5 | 95 |
| Embodiment 3-23 | 0.1 | 10 | 100.0 | 0.9 | 110 | 5000 | 45.5 | 87.8 | 100 |
| Embodiment 3-24 | 0.1 | 10 | 100.0 | 0.9 | 120 | 5000 | 41.7 | 88.3 | 100 |
| Embodiment 3-25 | 0.1 | 10 | 100.0 | 0.9 | 100 | 5500 | 55.0 | 88.1 | 95 |
| Embodiment 3-26 | 0.1 | 10 | 100.0 | 0.9 | 100 | 6000 | 60.0 | 88.6 | 95 |
| Embodiment 3-27 | 0.1 | 10 | 100.0 | 0.9 | 100 | 6400 | 64.0 | 89.1 | 100 |
| Embodiment 3-28 | 0.1 | 10 | 100.0 | 0.9 | 100 | 7000 | 70.0 | 87.5 | 100 |
| Embodiment 3-29 | 0.1 | 10 | 100.0 | 0.9 | 100 | 7200 | 72.0 | 85.6 | 90 |
| Embodiment 3-30 | 0.1 | 10 | 100.0 | 0.9 | 100 | 4800 | 48.0 | 85.9 | 90 |
| Embodiment 3-31 | 0.02 | 10 | 500.0 | 0.9 | 100 | 5000 | 50.0 | 83.7 | 85 |
| Embodiment 3-32 | 0.95 | 10 | 10.5 | 0.9 | 100 | 5000 | 50.0 | 82.4 | 85 |
| Embodiment 3-33 | 0.1 | 9 | 90.0 | 0.9 | 100 | 5000 | 50.0 | 81.8 | 75 |
| Embodiment 3-34 | 0.1 | 26 | 260.0 | 0.9 | 100 | 5000 | 50.0 | 81.3 | 75 |
| Embodiment 3-35 | 0.1 | 28 | 280.0 | 0.9 | 100 | 5000 | 50.0 | 80.5 | 70 |
| Embodiment 3-36 | 0.1 | 10 | 100.0 | 1.9 | 100 | 5000 | 50.0 | 81.2 | 85 |
| Embodiment 3-37 | 0.1 | 10 | 100.0 | 0.3 | 100 | 5000 | 50.0 | 82 | 85 |
| Embodiment 3-38 | 0.1 | 10 | 100.0 | 2 | 100 | 5000 | 50.0 | 80.5 | 80 |
| Embodiment 3-39 | 0.1 | 10 | 100.0 | 0.9 | 130 | 5000 | 38.5 | 83.2 | 80 |
| Embodiment 3-40 | 0.1 | 10 | 100.0 | 0.9 | 80 | 5000 | 62.5 | 84 | 80 |

Note: In Table 3, X %, Y %, and Z % represent the mass contents of lithium difluorophosphate, diethyl carbonate, and lithium bis(fluorosulfonyl)imide, respectively, based on the total mass of the electrolyte solution; T ppm represents the mass content of aluminum based on the mass of the positive active material layer; and C μm represents the thickness of the positive electrode plate.

As shown in Table 1, in the electrochemical apparatus of this application, when the average pore diameter of the porous layer is 0.5 μm to 18 μm and the content of propyl propionate in the electrolyte solution is 25% to 55%, the electrochemical apparatus exhibits short fast-charging time and low gas production, thereby demonstrating excellent fast-charging performance, cycle performance and safety performance.

In particular, as shown in Table 2, by controlling the bump height of the positive electrode plate, the type of the conductive agent, the BET of the conductive agent, the coating area density of the positive electrode plate, and the type of the binder in this application, the capacity retention rate of the electrochemical apparatus under fast charging can be improved, and the volume expansion rate during high-temperature storage can be suppressed.

In particular, as shown in Table 3, by controlling lithium difluorophosphate, diethyl carbonate, and lithium bis(fluorosulfonyl)imide in the electrolyte solution, as well as the thickness of the positive electrode plate and the content of aluminum in the positive electrode plate, the energy retention rate of the electrochemical apparatus at low temperatures and the safety performance under overcharge can be improved.

The above are merely embodiments of this application, but not intended to limit the protection scope of this application. To a person skilled in the art, various modifications and variations may be made to this application. Any modifications, equivalent replacements, improvements, and the like made within the spirit and principles of this application still fall within the scope of protection of this application.

What is claimed is:

1. An electrochemical apparatus, wherein the electrochemical apparatus comprises a separator, a positive electrode plate, and an electrolyte solution; wherein the separator comprises a porous layer, and an average pore diameter of the porous layer is 0.5 μm to 18 μm;
the electrolyte solution comprises propyl propionate; based on a mass of the electrolyte solution, a mass content of propyl propionate is 25% to 55%; and
the positive electrode plate comprises a positive active material layer, the positive active material layer comprises a conductive agent, the conductive agent comprises at least one of conductive carbon black or Ketjen black, and a specific surface area of the conductive agent is 600 m²/g to 1100 m²/g.

2. The electrochemical apparatus according to claim 1, wherein the average pore diameter of the porous layer is 0.5 μm to 10 μm.

3. The electrochemical apparatus according to claim 2, wherein the average pore diameter of the porous layer is 5 μm to 10 μm.

4. The electrochemical apparatus according to claim 1, wherein based on the mass of the electrolyte solution, a mass content of propyl propionate is 30.5% to 45%.

5. The electrochemical apparatus according to claim 4, wherein based on the mass of the electrolyte solution, the mass content of propyl propionate is 30.5% to 38.5%.

6. The electrochemical apparatus according to claim 1, wherein the electrochemical apparatus satisfies at least one of the following conditions (1) to (4):
(1) a thickness of the porous layer is 0.5 μm to 5 μm;
(2) the porous layer comprises 45 to 95 pores;
(3) the porous layer comprises inorganic particles, and a polymer of vinylidene fluoride and hexafluoropropylene; or
(4) the porous layer comprises inorganic particles, and a length-to-diameter ratio of the inorganic particles is 1:5 to 1:1.

7. The electrochemical apparatus according to claim 1, wherein the positive electrode plate is provided with bumps, and a height H₁ of the bumps satisfies: 20 μm≤H₁≤70 μm.

8. The electrochemical apparatus according to claim 1, wherein a coating area density of the positive electrode plate is 220 mg/1540.25 mm² to 320 mg/1540.25 mm².

9. The electrochemical apparatus according to claim 1, wherein the positive electrode plate comprises a binder, the binder comprises a first substance, a functional group of the first substance comprises a trihydroxy benzene ring; and based on X-ray diffraction characterization, the first substance has n peaks in a diffraction angle range of 50° to 70°, satisfying: 1≤n≤4.

10. The electrochemical apparatus according to claim 1, wherein the positive active material layer comprises aluminum, a mass content of aluminum element is T ppm based on a mass of the positive active material layer, and a thickness of the positive electrode plate is C μm, satisfying: 41.6≤T/C≤77.8.

11. The electrochemical apparatus according to claim 10, wherein 5000≤T≤6400.

12. The electrochemical apparatus according to claim 1, wherein the electrolyte solution comprises lithium difluorophosphate and diethyl carbonate; and based on the total mass of the electrolyte solution, a mass content of lithium difluorophosphate is X %, and a mass content of diethyl carbonate is Y %, satisfying: 11.1≤Y/X≤500.

13. The electrochemical apparatus according to claim 12, wherein 20≤Y/X≤360.

14. The electrochemical apparatus according to claim 1, wherein the electrolyte solution comprises lithium bis(fluorosulfonyl)imide; and based on the total mass of the electrolyte solution, a mass content of lithium bis(fluorosulfonyl)imide is Z %, satisfying: 0.4≤Z≤1.8.

15. The electrochemical apparatus according to claim 1, wherein the mass content of propyl propionate is 30.5% to 40%.

16. The electrochemical apparatus according to claim 1, wherein the mass content of propyl propionate is 35% to 38.5%.

17. An electronic device, comprising an electrochemical apparatus, wherein the electrochemical apparatus comprises a separator, a positive electrode plate, and an electrolyte solution; wherein the separator comprises a porous layer, and an average pore diameter of the porous layer is 0.5 μm to 18 μm;
the electrolyte solution comprises propyl propionate; based on a mass of the electrolyte solution, a mass content of propyl propionate is 25% to 55%; and
the positive electrode plate comprises a positive active material layer, the positive active material layer comprises a conductive agent, the conductive agent comprises at least one of conductive carbon black or Ketjen black, and a specific surface area of the conductive agent is 600 m²/g to 1100 m²/g.

18. The electronic device according to claim 17, wherein the average pore diameter of the porous layer is 0.5 μm to 10 μm.

19. The electronic device according to claim 17, wherein the average pore diameter of the porous layer is 5 μm to 10 μm.

20. The electronic device according to claim 17, wherein based on the mass of the electrolyte solution, a mass content of propyl propionate is 30.5% to 45%.
